(19) United States
(12) Patent Application Publication
(10) Pub. No.: US 2017/0175766 A1
(43) Pub. Date: Jun. 22, 2017

(54) GAS TURBINE ENGINE WITH ROTATING INLET

(71) Applicant: United Technologies Corporation, Farmington, CT (US)

(72) Inventors: Amr Ali, South Windsor, CT (US); Nigel David Sawyers-Abbott, South Glastonbury, CT (US)

(21) Appl. No.: 14/974,195

(22) Filed: Dec. 18, 2015

(51) Int. Cl. F04D 29/52; B64D 29/00; F04D 29/38; B64D 27/10; F04D 19/00; F02K 3/06

(52) U.S. Cl. CPC F04D 29/524; F04D 19/002; F02K 3/06; F04D 29/38; B64D 27/10; B64D 29/00; F05B 2220/303; F05B 2260/4031

(57) ABSTRACT

A gas turbine engine comprises a nacelle that encloses a fan rotor carrying a plurality of fan blades. The nacelle is formed with droop such that one portion extends axially further from the fan blades than does another portion. The nacelle is rotatable such that a circumferential location of the one portion and the other portion may be varied dependent on flight conditions. A method of operating a gas turbine engine is also disclosed.

### BACKGROUND OF THE INVENTION

This application relates to a gas turbine engine having minimized inlet distortion.

Gas turbine engines are known and typically include a fan delivering air into a bypass duct as propulsion air and into a compressor as core flow. The air is compressed in the compressor and delivered into a combustor where it is mixed with fuel and ignited. Products of this combustion pass downstream over turbine rotors, driving them to rotate.

Recently, a gear reduction has been incorporated between a fan drive turbine and the fan rotor. This has increased the design freedom for the gas turbine engine designer. In particular, the fan can now be made to rotate slower than the turbine. With this change, the diameter of the fan has increased.

It has recently been proposed to provide a gas turbine engine, where the inlet or area of a surrounding housing or nacelle forward of the fan rotor, is shorter than in the past. Providing a shorter inlet reduces the weight of the engine and also reduces external drag. Other benefits include reducing a bending moment and corresponding load on an engine structure during flight conditions such as takeoff. Further, by making the inlet shorter, the overall envelope of the engine is reduced.

However, the shorter inlets raise various challenges including a decreased ability to attenuate noise generated by the engine.

### SUMMARY OF THE INVENTION

In a featured embodiment, a gas turbine engine comprises a nacelle that encloses a fan rotor carrying a plurality of fan blades. The nacelle is formed with droop such that one portion extends axially further from the fan blades than does another portion. The nacelle is rotatable such that a circumferential location of the one portion and the other portion may be varied dependent on flight conditions.

In another embodiment according to the previous embodiment, the one portion is positioned within 10° of top dead center during conditions including cruise, and the other portion is positioned within 10° of top dead center during conditions including landing.

In another embodiment according to any of the previous embodiments, a motor drives a geared output member to engage gear teeth on the nacelle to cause the nacelle to rotate.

In another embodiment according to any of the previous embodiments, the nacelle is guided for rotation within a static structure.

In another embodiment according to any of the previous embodiments, a distance is defined from a plane defined by leading edges of the fan blades to an axial location of a forwardmost part of the nacelle. An outer diameter of the fan blades is defined, and a ratio of the distance to the outer diameter is between about 0.2 and about 0.5.

In another embodiment according to any of the previous embodiments, the ratio is greater than about 0.25.

In another embodiment according to any of the previous embodiments, the ratio is greater than about 0.30.

In another embodiment according to any of the previous embodiments, the ratio is less than about 0.40.

In another embodiment according to any of the previous embodiments, the distance measured to the one portion of the nacelle still results in a ratio less than about 0.45, and the distance measured to the other portion of the nacelle still results in the ratio greater than about 0.2.

In another embodiment according to any of the previous embodiments, a motor drives a geared output member to engage gear teeth on the nacelle to cause the nacelle to rotate.

In another featured embodiment, a method of operating a gas turbine engine includes positioning a nacelle about a fan rotor, with the fan rotor carrying a plurality of fan blades. The nacelle is formed with droop such that one portion extends axially further from the fan blades than does another portion. The nacelle is rotated such that the one portion and the other portion are positioned in distinct circumferential locations depending on flight conditions of an aircraft incorporating the engine.

In another embodiment according to the previous embodiment, the one portion is positioned within 10° of top dead center during conditions including cruise, and the other portion is positioned within 10° of top dead center during conditions including landing.

In another embodiment according to any of the previous embodiments, a motor drives a geared output member to engage gear teeth on the nacelle to cause the nacelle to rotate.

In another embodiment according to any of the previous embodiments, the nacelle is guided for rotation within a static structure.

In another embodiment according to any of the previous embodiments, a distance is defined from a plane defined by leading edges of the blades to an axial location of a forwardmost part of the nacelle. An outer diameter of the fan blades is defined, and a ratio of the distance to the outer diameter is between about 0.2 and about 0.5.

In another embodiment according to any of the previous embodiments, the ratio is greater than about 0.25.

In another embodiment according to any of the previous embodiments, the ratio is greater than about 0.30.

In another embodiment according to any of the previous embodiments, the ratio is less than about 0.40.

In another embodiment according to any of the previous embodiments, the distance measured to the one portion of the nacelle still results in a ratio less than about 0.45, and the distance measured to the other portion of the nacelle still results in the ratio greater than about 0.2.

In another embodiment according to any of the previous embodiments, a motor drives a geared output member to engage gear teeth on the nacelle to cause the nacelle to rotate.

These and other features may be best understood from the following drawings and specification.

### BRIEF DESCRIPTION OF THE DRAWINGS

FIG. 1 schematically shows an embodiment of a gas turbine engine.

FIG. 2 shows a challenge in short inlet engines.

FIG. 3 shows a first embodiment.

### DETAILED DESCRIPTION

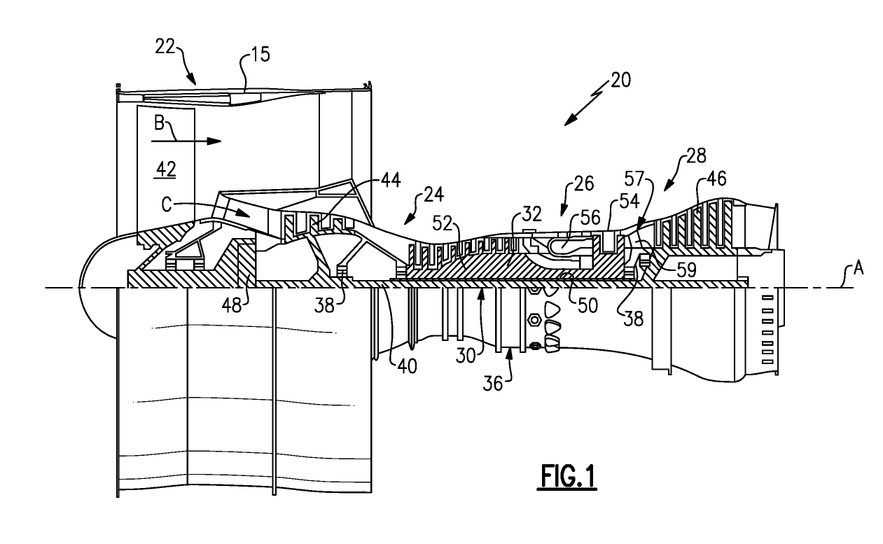

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFCT’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 meters/second).

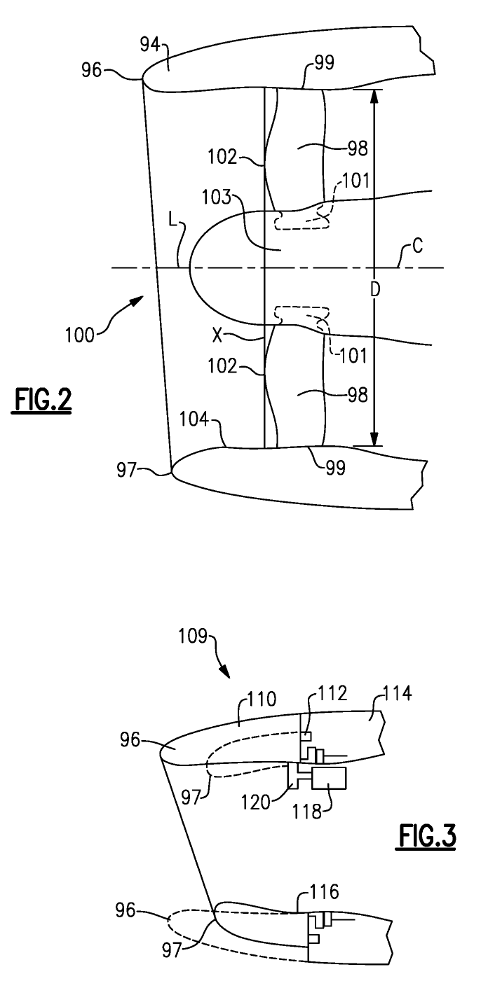

FIG. 2 shows an engine 100 known as a short inlet engine. As shown, a nacelle 94 has forwardmost ends 96 and 97. As can be seen, the forwardmost ends do not lie in a common plane perpendicular to a center axis of the engine. Rather, point 96 is further forward than point 97. Fan blades 98 have an outer diameter 99. The nacelle 94 is shown to have a radially inwardly extending innermost point 104. Point 104 is radially inward of the outer diameter 99 of the fan blade 98. As shown schematically, the fan blades 98 have a root section 101 received in a hub 103 of the fan rotor. Due to the radially innermost point 104, and the mounting of the blade, it could be difficult to remove a fan blade 98 from the engine.

The short inlet may be defined by a distance L measured from: (a) a plane X perpendicular to a central axis C, which plane also being tangent to a leading edge or forward most point 102 of the fan blade 98 to (b) a plane defined by the forwardmost points (including ends 96, 97) of the nacelle 94. A ratio is defined of L:D with D being the outer diameter of the fan blade 98.

In one embodiment L:D is between about 0.2 and about 0.45. Alternatively, the ratio may be greater than about 0.25 and in alternative embodiments greater than about 0.30. In embodiments, the ratio of L:D may be less than about 0.40.

As can be appreciated, the L:D quantity would be different if measured to the forward point 96 than to the forward point 97. However, in embodiments the ratio at the forward most point 96 would still be less than about 0.45, and the ratio at the shortest point 97 would still be greater than about 0.2.

Stated another way, the forwardmost end of the nacelle 94 extends outwardly for varying extents across the circumference of the nacelle, and the ratio of the L:D for all portions of the varying distance of the nacelle being between about 0.2 and about 0.45.

The different distances to the forwardmost ends 96 and 97 result in a nacelle configuration having a feature called “droop.”

FIG. 3 shows an engine 109 wherein the nacelle 110 may rotate.

The nacelle 110 has the droop feature, as explained above with regard to FIG. 2. As can be appreciated, the bottom dead center, or 6:00 point 97 defines a shorter length of the inlet before reaching the fan blade 98. There are benefits for having this orientation during flight. However, this arrangement would also result in increased noise because the shorter portion of the inlet that is facing the ground has less treatment to attenuate the radiated noise and also provides less shielding to the radiated noise towards he ground. This can raise noise issues such as during landing, or take-off, when the aircraft is closer to the earth.

Thus, the engine 109 has the rotatable nacelle 110. The nacelle 110 has some guiding structure, shown schematically at 112, which guides it in a static mount 114. The engine is shown with gear teeth 116 along the inner periphery of the nacelle 110. A motor 118 drives a geared output member 120, which can cause the rotatable nacelle 110 to rotate. It should be understood that this arrangement is a conceptual or basic arrangement for driving the nacelle 110 to rotate. It is envisioned that the ultimate drive structure would not be within the inner periphery of the nacelle 110, but incorporated in a manner that it will not interfere with airflow through the inlet provided by the nacelle 110.

When at cruise, the nacelle may be positioned as shown in FIG. 3 in solid line. However, when the aircraft is closer to the earth, such as for landing, or when it is taking off, the nacelle 110 may be rotated to the position shown in phantom, wherein the forward end 96 will now be at bottom dead center while the rearward end 97 will be at top dead center. It should be understood that intermediate locations may also be utilized. Generally, the rearward portion 97 would be positioned within 10° of top dead center in the position where reduced sound is desirable.

Stated another way, a nacelle 110 is positioned about a fan rotor 103, which carries a plurality of fan blades 98. The nacelle is formed with droop such that one portion 96 extends axially further from the fan blades than does another portion 97. The nacelle is rotated such that the one portion and the another portion are positioned in distinct circumferential locations depending on flight conditions of an aircraft incorporating the engine.

Although an embodiment has been disclosed, a worker of ordinary skill in this art would recognize that certain modifications would come within the scope of this disclosure. For that reason, the following claims should be studied to determine the true scope and content of this invention.

1. A gas turbine engine comprising:
a nacelle encloses a fan rotor carrying a plurality of fan blades, said nacelle is formed with droop such that one portion extends axially further from said fan blades than does another portion; and
said nacelle being rotatable such that a circumferential location of said one portion and said another portion may be varied dependent on flight conditions.

2. The gas turbine engine as set forth in claim 1, wherein said one portion is positioned within 10° of top dead center during conditions including cruise, and said another portion is positioned within 10° of top dead center during conditions including landing.

3. The gas turbine engine as set forth in claim 2, wherein a motor drives a geared output member to engage gear teeth on said nacelle to cause said nacelle to rotate.

4. The gas turbine engine as set forth in claim 1, wherein said nacelle is guided for rotation within a static structure.

5. The gas turbine engine as set forth in claim 1, wherein a distance is defined from a plane defined by leading edges of said fan blades to an axial location of a forwardmost part of said nacelle, and an outer diameter of said fan blades being defined, and a ratio of said distance to said outer diameter is between about 0.2 and about 0.5.

6. The gas turbine engine as set forth in claim 5, wherein said ratio being greater than about 0.25.

7. The gas turbine engine as set forth in claim 6, wherein said ratio is greater than about 0.30.

8. The gas turbine engine as set forth in claim 6, wherein said ratio is less than about 0.40.

9. The gas turbine engine as set forth in claim 5, wherein the distance measured to the one portion of said nacelle still results in a ratio less than about 0.45, and the distance being measured to the other portion of said nacelle still results in said ratio being greater than about 0.2.

10. The gas turbine engine as set forth in claim 1, wherein a motor drives a geared output member to engage gear teeth on said nacelle to cause said nacelle to rotate.

11. A method of operating a gas turbine engine comprising:
positioning a nacelle about a fan rotor, with said fan rotor carrying a plurality of fan blades, said nacelle being formed with droop such that one portion extends axially further from said fan blades than does another portion; and
rotating said nacelle such that said one portion and said another portion are positioned in distinct circumferential locations depending on flight conditions of an aircraft incorporating the engine.

12. The method as set forth in claim 11, wherein said one portion is positioned within 10° of top dead center during conditions including cruise, and said another portion is positioned within 10° of top dead center during conditions including landing.

13. The method as set forth in claim 12, wherein a motor drives a geared output member to engage gear teeth on said nacelle to cause said nacelle to rotate.

14. The method as set forth in claim 11, wherein said nacelle is guided for rotation within a static structure.

15. The method as set forth in claim 11, wherein a distance is defined from a plane defined by leading edges of said blades to an axial location of a forwardmost part of said nacelle, and an outer diameter of said fan blades being defined, and a ratio of said distance to said outer diameter is between about 0.2 and about 0.5.

16. The method as set forth in claim 15, wherein said ratio being greater than about 0.25.

17. The method as set forth in claim 16, wherein said ratio is greater than about 0.30.

18. The method as set forth in claim 16, wherein said ratio is less than about 0.40.

19. The method as set forth in claim 15, wherein the distance measured to the one portion of said nacelle still results in a ratio less than about 0.45, and the distance being measured to the other portion of said nacelle still results in said ratio being greater than about 0.2.

20. The method as set forth in claim 11, wherein a motor drives a geared output member to engage gear teeth on said nacelle to cause said nacelle to rotate.
